(19) United States
(12) Patent Application Publication
(10) Pub. No.: US 2018/0174183 A1
(43) Pub. Date: Jun. 21, 2018

(54) CALCULATION DEVICE, INDEX INFORMATION, CALCULATION METHOD, AND NON-TRANSITORY COMPUTER READABLE STORAGE MEDIUM

(71) Applicant: YAHOO JAPAN CORPORATION, Tokyo (JP)

(72) Inventors: Youhei MORISHITA, Tokyo (JP); Naoki ISHIKAWA, Tokyo (JP); Masayuki YANO, Tokyo (JP)

(73) Assignee: YAHOO JAPAN CORPORATION, Tokyo (JP)

(21) Appl. No.: 15/694,123

(22) Filed: Sep. 1, 2017

(30) Foreign Application Priority Data
Dec. 20, 2016 (JP) 2016-246629

(51) Int. Cl. G06Q 30/02

(52) U.S. Cl. CPC G06Q 30/0251; G06Q 30/0275

(57) ABSTRACT

According to one aspect of an embodiment a calculation device includes a determination unit that determines whether each of the pieces of the attribute information matches each of the conditions. The calculation device includes a decision unit that decides, on the basis of whether the continuous values included in the index information that is associated with the condition determined to be matched with the attribute information continue up to the predetermined value, whether the predetermined information is specified as the distribution target. The calculation device includes a calculation unit that calculates by using the coefficient that is included in the index information and that is associated with the condition that is determined to be matched with the attribute information, a priority at the time of distribution of the predetermined information.

### CROSS-REFERENCE TO RELATED APPLICATION

The present application claims priority to and incorporates by reference the entire contents of Japanese Patent Application No. 2016-246629 filed in Japan on Dec. 20, 2016.

### BACKGROUND OF THE INVENTION

### 1. Field of the Invention

The present invention relates to a calculation device, index information, a calculation method, and a non-transitory computer readable storage medium.

### 2. Description of the Related Art

In recent years, with the rapid spread of the Internet, information distribution based on information acquired via a network has been actively performed. For example, targeting distribution in which an attribute of a user targeted for the distribution destination of the information is previously registered as distribution destination information and information associated with the attribute of the user targeted for the distribution destination is selectively distributed is performed. As this type of information distribution, there is a known technology that searches for information associated with the attribute of the user targeted for the distribution destination by attaching a boolean (logical value) condition to the information itself that becomes the distribution target. Furthermore, there is known bidding-type information distribution in which a bid amount is previously set in information that becomes the distribution target and the information associated with the attribute of a user targeted for the distribution destination is distributed in accordance with the priority of the bid amount.
Patent Document 1: Japanese Laid-open Patent Publication No. 2016-153972.
Non-Patent Document 1: Steven Euijong Whang, Hector Garcia-Molina, Chad Brower, Jayavel Shanmugasundaram, Sergei Vassilvitskii, Erik Vee, “Indexing Boolean Expressions” [online], [searched on Nov. 30, 2016], Internet (http://theory.stanford.edu/˜sergei/papers/vldb09-indexing.pdf).

However, in the conventional technology described above, there may be a case in which information that becomes the distribution target is not always promptly extracted.

For example, regarding a certain piece of information, there may be a request to set a different bid amount for each attribute of a user who becomes the target for the distribution destination. However, to realize such a request, in the conventional technology, distribution destination information is set for each combination of the attribute and a bid amount. Consequently, the number of pieces of the distribution destination information to be compared with a query is increased. This can possibly result in an inability to promptly extract the information that becomes the distribution target.

### SUMMARY OF THE INVENTION

It is an object of the present invention to at least partially solve the problems in the conventional technology.

According to one aspect of an embodiment a calculation device includes a determination unit that (i) refers to, when a plurality of pieces of attribute information indicating an attribute of a distribution destination is received, regarding each of a plurality of conditions that indicates an attribute and for which predetermined information becomes the distribution target when a logical conjunction is satisfied, a storage device that stores therein, in an associated manner, index information including continuous values constituting values continued up to a predetermined value at the time of connection and coefficients, and (ii) that determines whether each of the pieces of the attribute information matches each of the conditions. The calculation device includes a decision unit that decides, on the basis of whether the continuous values included in the index information that is associated with the condition determined to be matched with the attribute information continue up to the predetermined value, whether the predetermined information is specified as the distribution target. The calculation device includes a calculation unit that calculates, every time it is determined that the attribute information matches the condition, by using the coefficient that is included in the index information and that is associated with the condition that is determined to be matched with the attribute information, a priority at the time of distribution of the predetermined information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a calculation process performed by an information distribution device according to an embodiment;

FIG. 2 is a diagram illustrating a configuration example of the information distribution device according to the embodiment;

FIG. 3 is a diagram illustrating an example of information registered in an advertisement database according to the embodiment;

FIG. 4 is a diagram illustrating an example of information registered in an index database according to the embodiment;

FIG. 5 is a diagram illustrating an example of a process in which the information distribution device according to the embodiment calculates coefficient product;

FIG. 6 is a flowchart illustrating an example of the flow of a calculation process performed by the information distribution device according to the embodiment; and

FIG. 7 is a block diagram illustrating an example of hardware configuration.

### DETAILED DESCRIPTION OF THE PREFERRED EMBODIMENTS

Hereinafter, modes (hereinafter, referred to as “embodiments”) for carrying out a calculation device, index information, a calculation method, and a non-transitory computer readable storage medium according to the present invention will be described in detail with reference to drawings. Furthermore, the calculation device, the index information, the calculation method, and the non-transitory computer readable storage medium according to the present invention are not limited to the embodiments. Furthermore, in the embodiments described below, the same components are denoted by the same reference numerals and an overlapping explanation will be omitted.

### Embodiment

1. Example of an Information Distribution Device

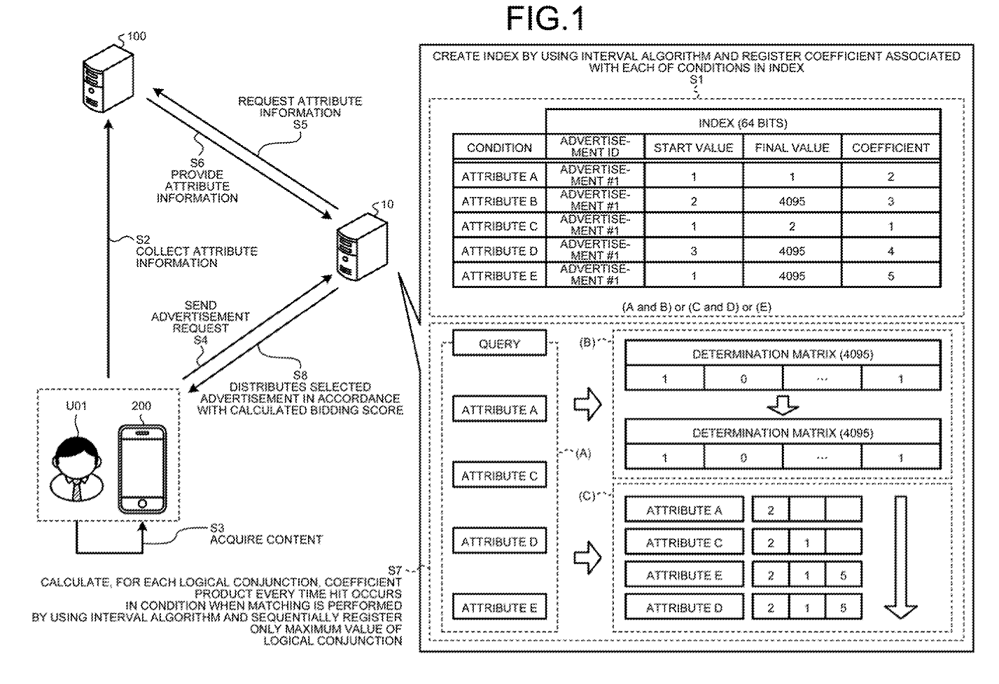

First, an example of a calculation process that is performed by an information distribution device and that is an example of a calculation process will be described with reference to FIG. 1. FIG. 1 is a diagram illustrating an example of the calculation process performed by an information distribution device according to the embodiment.

Furthermore, in a description below, an example in which an information distribution device 10 distributes content related to an advertisement to a user terminal 200 used by a user U01; however, the embodiment is not limited to this. Namely, the information distribution device 10 may also distribute arbitrary content to the user U01 as long as the information distribution device 10 distributes content that is in accordance with various kinds of attributes of the user U01, such as demographic attributes or psychographic attributes of the user U01, an action history of the user U01, or the like.

Furthermore, it is assumed that the content related to an advertisement is not only a profit-oriented or nonprofit advertisement but also recruitment of volunteers, a public service advertisement, a public notification, or another arbitrary piece of content. Namely, in addition to the content including the information related to a so-called advertisement, content may also include an image, a moving image, characters, a diagram, a symbol, a hyperlink, or another arbitrary piece of content together with a text as long as the content is interested by a user and the content widely notifies of information included in the content or information included in content (for example, a landing page, etc.) associated with the content. Furthermore, if the content is content related to an advertisement, an information processing apparatus (for example, a distribution source server 300) that registers the advertisement may also be, in addition to an information processing apparatus used by a so-called advertiser, an information processing apparatus used by an advertising agency that creates or registers an advertisement requested by an advertiser.

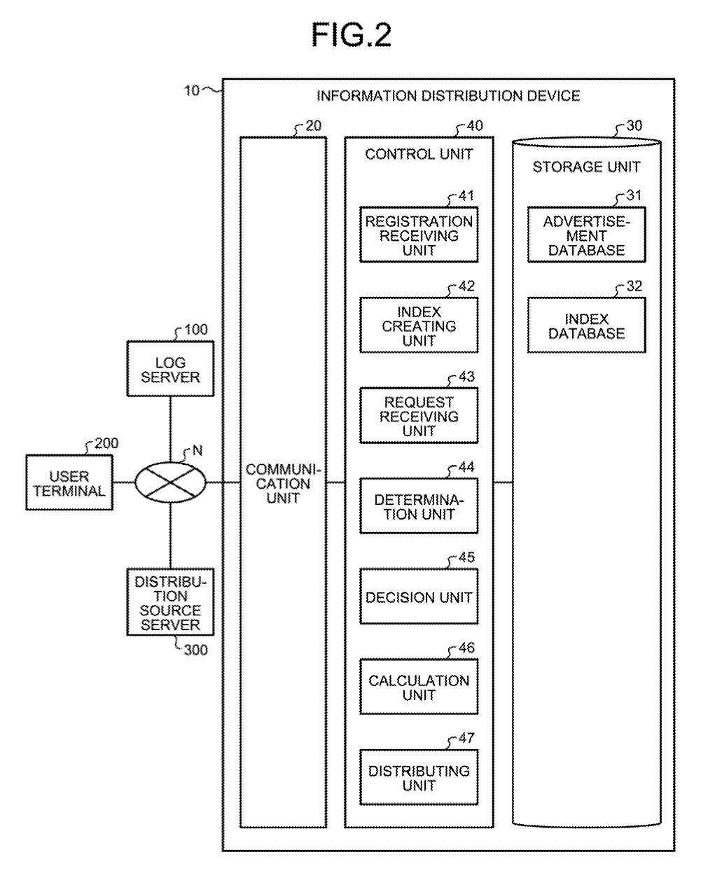

The information distribution device 10 is an information processing apparatus that can communicate with, via a predetermined network N, such as the Internet, or the like, a log server 100, the user terminal 200, and the distribution source server 300 (for example, see FIG. 2) used by the distribution source that requests to distribute an advertisement and is implemented by, for example, a server device, a cloud system, or the like. Furthermore, the information distribution device 10 may also communicate with, via the network N, an arbitrary number of the log servers 100, the user terminals 200, and the distribution source servers 300.

The log server 100 collects various kinds of logs related to the user U01. For example, the log server 100 collects, as attribute information on the user U01, arbitrary information related to the user U01, such as a demographic attribute including the gender, an age group, the address, or the like, of the user U01; a psychographic attribute including hobbies, taste, or the like of the user U01; the current location of the user U01; a browsing history of web content; a purchase history of the object purchased via electronic commerce; a history of a search query; or the like. Furthermore, the attribute information on the user U01 is acquired by using a technology of, for example, Bcookie, or the like.

The user terminal 200 is a smart device, such as a smartphone, a tablet terminal, or the like, and is a mobile terminal device that can communicate with an arbitrary server device via a wireless communication network, such as third Generation (3G), Long Term Evolution (LTE), or the like. Furthermore, the user terminal 200 may also be, in addition to a smartphone, an information processing apparatus, such as a desktop personal computer (PC), a notebook PC, or the like.

The distribution source server 300 is an information processing apparatus used by the distribution source of an advertisement and is implemented by a server device, a PC, or the like. For example, when the distribution source server 300 registers an advertisement that becomes the distribution target in the information distribution device 10, the distribution source server 300 registers condition information indicating a condition of a user targeted for the distribution destination of the advertisement. More specifically, the distribution source server 300 specifies the attribute of the user targeted for the distribution destination by using a Boolean operation expression. For example, if the distribution source server 300 wants to distribute an advertisement #1 to the user having the attribute of a “male” in his “thirties” interested in plastic models, the distribution source server 300 registers, as the condition information of the advertisement #1, the distribution source server 300 registers, as the condition information of the advertisement #1, the Boolean operation expression of “thirties and male and plastic models” constituted by the condition of “thirties”, “male”, and “plastic models”.

In such a case, if the distribution source server 300 receives a distribution request for the advertisement from the user terminal 200, the distribution source server 300 acquires the attribute information on the user U01 from the log server 100. Then, the distribution source server 300 determines whether the acquired attribute information satisfies the condition information of “thirties and male and plastic models” and distributes, if the attribute information satisfies the logical expression, the advertisement #1 to the user terminal 200. Namely, the information distribution device 10 performs a targeting search of the content by using the Boolean operation expression.

In a description below, each of the attributes included in the condition information that is previously set to the advertisement that becomes the distribution target, i.e., the attribute of each of the elements of the Boolean operation expression, is correctively referred to as a “condition”.

2. About Distribution of an Advertisement

Here, there is a known distribution technology with a bidding system that selects, based on a bidding score that is previously set in an advertisement, an advertisement that becomes the distribution target. In this bidding system, a bidding score is previously set in an advertisement and, from among advertisements that are selected based on attribute information on a user who becomes the target for the distribution destination of the advertisement, the advertisement having a high bidding score is distributed with priority.

Here, there may be a request to set a bidding score for each attribute of a user who becomes the target for the distribution destination. However, it takes a lot of time and effort to set a bidding score for each attribute of a user who becomes the target for the distribution destination. Thus, it is conceivable to use a technology that sets a bidding score for each advertisement and that sets a coefficient for each attribute.

For example, the information distribution device 10 receives the setting of, with respect to the advertisement #1, a combination of the condition information “thirties or plastic models”, the bidding score “100”, and the attribute “thirties” and the coefficient “1.5” and a combination of the attribute “plastic models” and the coefficient “0.8”. Then, if the attribute of the user who becomes the target for the distribution destination is the attribute “thirties”, the information distribution device 10 distributes the advertisement #1 by using, as a value of the bidding score, the value “150” that is the product of the coefficient “1.5” associated with the attribute “thirties” and the bidding score “100”. In contrast, if the attribute of the user who becomes the target for the distribution destination is the attribute “plastic models”, the information distribution device 10 distributes the advertisement #1 by using, as a value of the bidding score, the value “80” of the product of the coefficient “0.8” associated with the attribute “plastic models” and the bidding score “100”.

However, with such a technology, there may possibly be a case in which an advertisement that becomes the distribution target is not able to promptly be extracted. For example, the information distribution device 10 can implement the process described above by creating, as the index of the advertisement #1, the combination of the condition information “thirties” and the bidding score “150” and the combination of the condition information “plastic models” and the bidding score “80”. However, with this technology, because the index needs to be created for each combination of condition information and a coefficient, the number of indexes that are compared with the attribute of the user who becomes the target for the distribution destination is increased and this can possibly result in a decrease in the search performance of the advertisement that becomes the distribution target. Furthermore, if the condition information includes logical conjunctions of a plurality of conditions or logical disjunctions of a plurality of conditions, such as “(thirties and male) or (plastic models and thirties)”, or the like, combination of the conditions may possibly be further increased.

2-1. About a Calculation Process

Thus, by performing the logical operation using an interval algorithm, the information distribution device 10 selects the advertisement associated with the condition information fit for the attribute condition of the user who becomes the target for the distribution destination. When performing such a logical operation, regarding each of a plurality of conditions that indicates an attribute of a user who becomes the target for the distribution destination and for which the advertisement becomes the distribution target when the logical conjunction is satisfied, the information distribution device 10 creates an index that includes continuous values constituting values continued up to a predetermined value at the time of connection. Then, on the basis of whether the continuous values included in the index of the condition that is matched with the attribute of the user who becomes the target for the distribution destination continue up to a predetermined threshold, the information distribution device 10 determines whether the logical conjunction of the condition is satisfied.

Furthermore, the information distribution device 10 performs the following calculation process. First, the information distribution device 10 creates, as the index associated with the condition, an index that includes not only the continuous values used for the interval algorithm but also the coefficients each of which is set with respect to the condition. Then, if the information distribution device 10 receives, as a query, a plurality of pieces of attribute information that indicates the attribute of the distribution destination, the information distribution device 10 determines whether the attribute information included in the query matches each of the conditions associated with the index. Furthermore, on the basis of whether the continuous values that are included in the index and that are associated with the condition that is determined to be matched with the attribute information included in the query continue up to the predetermined value, the information distribution device 10 determines whether the advertisement is specified as the distribution target. Here, every time it is determined that the attribute information included in the query matches the condition, by using the coefficient that is included in the index and that is associated with the condition that is determined to be matched with the attribute information, the information distribution device 10 calculates the priority at the time of distribution of the advertisement, i.e., a bidding score.

More specifically, there may be a case in which the information distribution device 10 stores therein a plurality of combinations of conditions for which the advertisement becomes the distribution target if the logical conjunction is satisfied, i.e., a plurality of combinations of conditions constituting the logical conjunction (hereinafter, collectively referred to as “combinations of logical conjunctions”). For example, if a logical conjunction is satisfied, such as “(A and B) or (C and D) or (E)”, the information distribution device 10 stores therein a combination of the conditions “A” and “B”, a combination of the conditions “C” and “D”, and a combination of the condition “E” that are condition of the advertisement to be the distribution target. In such a case, the information distribution device 10 calculates, for each combination of logical conjunction, the value of the product of the coefficients that are included in the index and that are associated with the conditions that are determined to be matched with the attribute information (hereinafter, collectively referred to as the “coefficient product”).

For example, regarding the advertisement with the condition information “(A and B) or (C and D) or (E)”, if all of the conditions “A” to “E” match the attribute information, the information distribution device 10 uses the greatest value as the bidding score of the advertisement from among the product of the coefficient of the attribute “A” and the coefficient of the attribute “B”, the product of the coefficient of the attribute “C” and the coefficient of the attribute “D”, and the coefficient of the attribute “E”. Furthermore, for example, if the attribute information in the query matches the conditions “A”, “B”, “C”, and “E”, the information distribution device 10 uses the greatest value between the coefficient product of the coefficient of the condition “A” and the coefficient of the condition “B” and the coefficient of the condition “E” as the bidding score.

Furthermore, if each of the plurality of combinations includes the plurality of conditions and if the logical disjunction of the conditions included in each of the combinations is satisfied, the information distribution device 10 sometimes stores therein the condition information for which the advertisement becomes the distribution target. For example, if the condition “A” or “B” matches the attribute information, if the condition “C” or “D” matches the attribute information, and if the condition “E” matches the attribute information, such as the condition information “(A or B) and (C or D) and (E)”, the information distribution device 10 sometimes stores therein the attribute information indicating that the advertisement is distributed. Regarding such condition information, if all of the attributes “A” to “E” match the attribute information, the information distribution device 10 uses, as the bidding score of the advertisement, the greatest value from among the coefficient product of the attributes “A”, “C”, and “E”, the coefficient product of the attributes “A”, “D”, and “E”, the coefficient product of the attributes “B”, “C”, and “E”, and the coefficient product of the attributes “B”, “D”, and “E”.

Namely, when the information distribution device 10 describes a combination of the conditions that are connected by “and” or “or”, a combination of the logical conjunctions, or a combination of the logical disjunctions as a “feature”, the information distribution device 10 holds, if the two features connected by “and” match the attribute information, the product of the coefficients of the two features that are matched with the attribute information. In contrast, if the two features connected by “or” match the attribute information, the information distribution device 10 holds the coefficient having a greater value between the coefficients of the two features that are matched with the attribute information.

2-2. About Dynamic Programming

At this time, the information distribution device 10 determines, in the order based on the dynamic programming, whether the attribute information matches the condition that is included in the condition information. More specifically, the information distribution device 10 determines whether the condition included in the combination, from among combinations of a logical conjunction, in which the value of the end of the continuous values associated with the condition that is determined to be matched with the attribute information is the smallest matches the attribute information.

For example, in the interval algorithm, continuous values with a predetermined value used as an upper limit are allocated to a plurality of the conditions included in the combinations of the logical conjunctions. For example, the information distribution device 10 stores therein the condition information “(A and B) or (C and D) or (E)” on a certain advertisement. In such a case, if the condition of the continuous values is “4095”, the information distribution device 10 allocates the start value “1” and the final value “1” to the condition “A” as the continuous values and allocates the start value “2” and the final value “4095” to the condition “B” as the continuous values. Furthermore, the information distribution device 10 allocates the start value “1” and the final value “2” to the condition “C” as the continuous values and allocates the start value “3” and the final value “4095” to the condition “D” as the continuous values. Furthermore, the information distribution device 10 allocates the start value “1” and the final value “4095” to the condition “E” as the continuous values.

If such continuous values are allocated, the information distribution device 10 can determine whether the logical conjunction is satisfied in accordance whether the continuous values of the condition matched with the attribute information continue from “1” to “4095”. For example, if the conditions “A”, “C”, and “D” match the attribute information, the continuous values continue from “1” to “4095” when the start value “1” and the final value “2” of the condition “C” are connected to the start value “3” and the final value “4095” of the condition “D”, respectively; therefore, the logical conjunction of the condition “C” and the condition “D” is satisfied and thus the information distribution device 10 can specify that the advertisement is the distribution target.

When performing such an interval algorithm, for each combination of the logical conjunction included in the condition information, the information distribution device 10 refers to the value of the end of the continuous values of the condition that is matched with the attribute information and selects the combination of the logical conjunction in which the referred value is the smallest. Then, the information distribution device 10 selects, from among the conditions included in the selected combination of the logical conjunction, the condition that is not compared with the attribute information and determines whether the selected condition matches the attribute information. By continuously performing this process, the information distribution device 10 determines whether all of the conditions included in the combination of each of the logical conjunctions match the attribute information included in the query.

2-3. About a Specific Process of Calculating a Coefficient

At this point, if the information distribution device 10 determines, in the order based on the dynamic programming, whether the condition matches the attribute information, the information distribution device 10 holds, for each combination of the logical conjunction, the history of the coefficient product of the condition that is matched with the attribute information up to that time and adds up, every time the attribute information matches the condition, the coefficient included in the index of the subject condition to the history of the coefficient product of the combination of the logical conjunction that includes the subject condition. Namely, if the attribute information matches the condition, the information distribution device 10 calculates the product of the value of the coefficient associated with the subject condition and the coefficient product of the combinations of the logical conjunction that includes the subject condition.

For example, if the attribute information matches the condition, the information distribution device 10 calculates the product of the value of the coefficient associated with the subject condition and the coefficient that is associated with the condition matched with the attribute information from among the conditions included in the combination of the logical conjunction that includes the subject condition. Then, if the value of the calculated product is greater than the value of the product of the coefficient that is associated with the condition matched with the attribute information from among the conditions included in the combination of the other logical conjunction, the information distribution device 10 holds the value of the calculated product by associating the value with the combination of the logical conjunction that includes the condition that is matched with the attribute information. In contrast, if the value of the calculated product is equal to or less than the value of the product of the coefficient that is associated with the condition matched with the attribute information from among the conditions included in the combination of the other logical conjunction, the information distribution device 10 discards the value of the calculated product.

Furthermore, if each of the plurality of combinations of the logical disjunctions includes the plurality of conditions and if the logical disjunction of the conditions included in each of the combinations is satisfied, the information distribution device 10 may sometimes store the condition information indicating that the advertisement is the distribution target. Regarding this type of condition information, if the attribute information matches the condition, the information distribution device 10 calculates the product of the value of the coefficient associated with the subject condition and the coefficient that is associated with the condition matched with the attribute information from among the conditions included in the combination of the logical disjunction other than the combination of the logical disjunction that includes the subject condition. If the value of the calculated product is greater than the value of the product calculated up to that time, the information distribution device 10 holds the value of the calculated product by associating the value with the combination that includes the condition matched with the attribute information. In contrast, if the value of the calculated product is equal to or less than the product calculated up to that time, the information distribution device 10 discards the value of the calculated product.

Furthermore, a specific example of calculating a coefficient performed by using a numerical value will be described later.

2-4. About not

Here, in some cases, the attribute of a user excluded from the distribution destination is included as a condition in the condition information. For example, if the attribute information “A” is included in the attribute information on the user U01, the condition information “not A” indicating that an advertisement is not distributed is sometimes included in the condition information. In this way, if the condition indicating the attribute of the distribution destination that does not become the distribution destination of the advertisement matches the attribute information, the information distribution device 10 inverts the positive and the negative values of the coefficient associated with the subject condition and calculates a bidding score. For example, if the condition information is “A and (not B)”, the coefficient “2” is set related to the condition “A” and the condition “B”, and the attribute information included in the query is “A” and “B”, the information distribution device 10 uses the coefficient product “−4” of the coefficient “2” of the condition “A” and the coefficient “−2” that is obtained by inverting the sign of the coefficient “2” of the condition “B” as a bidding score.

Furthermore, if all of the conditions included in the combinations of the conditions constituting the logical conjunction, from among the conditions included in the combinations of the logical conjunction, are the conditions that indicate the attribute of the distribution destination that does not become the distribution destination of the predetermined information and if all of the conditions match the attribute information, the information distribution device 10 may also set a flag indicating the predetermined information is excluded from the distribution target.

2-5. About Data Size

Here, in the latency of searching for information performed by using an index, the effect of the latency generated when an arithmetic processing device reads the index is included. Accordingly, the index is preferably the data size that is easily read by the arithmetic processing device. Thus, the information distribution device 10 reads, as the index, information that includes an advertisement ID (identifier), which is an identifier indicating the associated advertisement, continuous values, and a coefficient that that has the data length equal to or less than the number of bits that can be read by the arithmetic processing device by a single access.

For example, if the core of the arithmetic processing device can read the 64-bit data by performing a single process, the information distribution device 10 may also create and store the index having a total of 64 bits including a 32-bit advertisement ID, a 12-bit start value, a 12-bit final value, and an 8-bit coefficient. Furthermore, an arbitrary value can be used for the number of bits of the index in accordance with the number of bits of the data that can be read by the core of the arithmetic processing device in a single process. Furthermore, an arbitrary value can be used for the number of bits of each of the pieces of the information included in the index in accordance with the maximum value of the value used for the advertisement ID, the maximum value of continuous values, and the maximum value of a coefficient.

2-6. About the Calculation Process Performed by the Information Distribution Device

In the following, a specific example of the calculation process performed by the information distribution device 10 will be described. Furthermore, in the example illustrated in FIG. 1, the attribute information “A” to “E” and the conditions “A” to “E” are referred to as the “attribute A” to the “attribute E”. First, the information distribution device 10 receives the advertisement that becomes the distribution target, the condition information, and the coefficient. In such a case, the information distribution device 10 creates an index by using the interval algorithm and registers the coefficient associated with each of the conditions in the index (Step S1).

For example, the information distribution device 10 receives the data on the advertisement and the condition information of “(A and B) or (C and D) or (E)”. Furthermore, information distribution device 10 receives the coefficient “2” associated with the condition “A”, the coefficient “3” associated with the condition “B”, the coefficient “1” associated with the condition “C”, the coefficient “4” associated with the condition “D”, and the coefficient “5” associated with the condition “E”.

In such a case, the information distribution device 10 allocates the same range, from among the continuous values of 1 to 4095, to a plurality of features constituting the logical disjunction and allocates the continuous values of 1 to 4095 to one or a plurality of features constituting the logical conjunction. For example, the information distribution device 10 allocates the start value “1” and the final value “1” to the condition “A” as the continuous values and allocates the start value “2” and the final value “4095” to the condition “B” as the continuous values. Furthermore, the information distribution device 10 allocates the start value “1” and the final value “2” to the condition “C” as the continuous values, allocates the start value “3” and the final value “4095” to the condition “D” as the continuous values, and allocates the start value “1” and the final value “4095” to the condition “E” as the continuous values. Then, the information distribution device 10 creates the advertisement ID “advertisement #1” that identifies the received advertisement; creates a 64-bit index including an advertisement ID, a start value, a final value, and a coefficient; and stores the created index.

In contrast, the log server 100 collects the attribute information on the user U01 at a predetermined timing (Step S2). For example, the log server 100 collects, as the attribute information, the gender, the age group, and the living district of the user U01, a history of a search query, a matter of interest or concern, or the like. Furthermore, the log server 100 may also acquire the attribute information on the user U01 by collecting various kinds of logs related to an operation or browsing performed by the user U01 and by analyzing the collected logs.

At this time, it is assumed that the user terminal 200 has acquired, in accordance with the operation performed by the user U01, various kinds of web content from a web server (not illustrated) (Step S3). In this web content, a predetermined advertisement area is arranged and an instruction to acquire the advertisement that is arranged in the advertisement area and that is displayed on that area is included. Thus, the user terminal 200 sends an advertisement request to the information distribution device 10 (Step S4).

In such a case, the information distribution device 10 requests the log server 100 to send the attribute information on the user U01 (Step S5). Consequently, the log server 100 provides the attribute information on the user U01 to the information distribution device 10 (Step S6). Then, the information distribution device 10 performs, by using the interval algorithm, the matching of the condition information of the advertisement and the attribute information on the user U01, calculates, for each logical conjunction, coefficient product every time the condition matches the attribute information, and sequentially registers only the maximum value of the logical conjunction (Step S7).

For example, the information distribution device 10 receives the attribute information “A”, “C”, “D”, and “E” on the user U01 from the log server 100. In such a case, as indicated by (A) illustrated in FIG. 1, the information distribution device 10 specifies the attribute information “A”, “C”, “D”, and “E” as a query. Then, as indicated by (B) illustrated in FIG. 1, the information distribution device 10 determines, by using the determination matrix that includes 4095 elements, whether the condition of the advertisement indicated by the advertisement ID “advertisement #1” matches the attribute information. Furthermore, as indicated by (C) illustrated in FIG. 1, every time the condition of the advertisement matches the attribute information, the information distribution device 10 calculates, for each logical conjunction, the coefficient product of the conditions matched with the attribute information.

For example, in the example illustrated in FIG. 1, the information distribution device 10 refers to the final value of each of the conditions and selects the condition “A” in which the value of the final value is the smallest. Here, because the attribute “A” is included in the query, the information distribution device 10 stores “1” in the element, in the determination matrix, that is associated with the start value “1” and the final value “1” that are associated with the condition “A”. Furthermore, as indicated by (C) illustrated in FIG. 1, the information distribution device 10 stores the coefficient “2” of the condition “A” in the array associated with the logical conjunction “(A and B)” in which the condition “A” is included.

Subsequently, the information distribution device 10 refers to the final value of the condition that is not compared with the query from among the conditions and then selects the condition “C” in which the value of the final value is the smallest. Here, because the attribute “C” is included in the query, the information distribution device 10 stores “1” in the element, in the determination matrix, that is associated with the start value “1” of the condition “C” and the element that are associated with the final value “2”. Furthermore, the information distribution device 10 stores the coefficient “1” of the condition “C” in the array associated with the logical conjunction “(C and D)” in which the condition “C” is included.

Subsequently, the information distribution device 10 refers to the final value of the condition that is not compared with the query from among the conditions and selects the condition “E” in which the value of the final value is the smallest. Here, because the attribute “E” is included in the query, the information distribution device 10 stores “1” in the element, in the determination matrix, that is associated with the start value “1” of the condition “E” and the element that are associated with the final value “4095”. Consequently, because “1” is stored in the bottom of the determination matrix, the information distribution device 10 determines that the condition information of the advertisement ID “advertisement #1” matches the query. Furthermore, the information distribution device 10 stores the coefficient “5” of the condition “E” in the array associated with the condition “E”.

Subsequently, the information distribution device 10 refers to the final value of the condition that is not compared with the query from among the conditions and selects the condition “B” in which the value of the final value is the smallest. However, because the attribute “B” is not included in the query, the information distribution device 10 selects the condition “D” in which the value of the final value is the second smallest. Here, because the attribute “D” is included in the query, the information distribution device 10 stores “1” in the element, in the determination matrix, that is associated with the start value “3” of the condition “D” and the element that are associated with the final value “4095”. Consequently, because “1” is stored in the bottom of the determination matrix, the information distribution device 10 determines that the condition information of the advertisement ID “advertisement #1” matches the query.

Here, the coefficient “1” is registered in the array of the logical conjunction associated with the condition “D”. Thus, the information distribution device 10 calculates the coefficient product “4” of the coefficient “1” and the coefficient “4” of the condition “D” and determines whether the obtained result is greater than the value stored in each of the arrays. Here, in the example illustrated in FIG. 1, the coefficient “5” is registered in the array that is associated with the condition “E”. Consequently, the information distribution device 10 discards the coefficient product “4” without registering in the array.

Then, after having determined whether each of the conditions matches the attribute information, the information distribution device 10 refers to the value registered in each of the arrays, i.e., the coefficient product, and acquires the greatest value. Then, the information distribution device 10 calculates, based on the acquired value, the bidding score of the advertisement indicated by the advertisement ID “advertisement #1”. Then, the information distribution device 10 selects, in accordance with the calculated bidding score, the advertisement that becomes the distribution target and distributes the selected advertisement to the user terminal 200 (Step S8).

3. Configuration of the Information Distribution Device

In the following, a description will be given of an example of the functional configuration of the information distribution device 10 described above. FIG. 2 is a diagram illustrating a configuration example of the information distribution device according to the embodiment. As illustrated in FIG. 2, the information distribution device 10 includes a communication unit 20, a storage unit 30, and a control unit 40.

The communication unit 20 is implemented by, for example, a network interface card (NIC), or the like. Then, the communication unit 20 is connected to a network N in a wired or a wireless manner and sends and receives information to and from the information distribution device 10 or the user terminal 200.

The storage unit 30 is implemented by, for example, a semiconductor memory device, such as a random access memory (RAM), a flash memory, or the like, or a storage device, such as a hard disk, an optical disk, or the like. Furthermore, the storage unit 30 stores therein an advertisement database 31 and an index database 32.

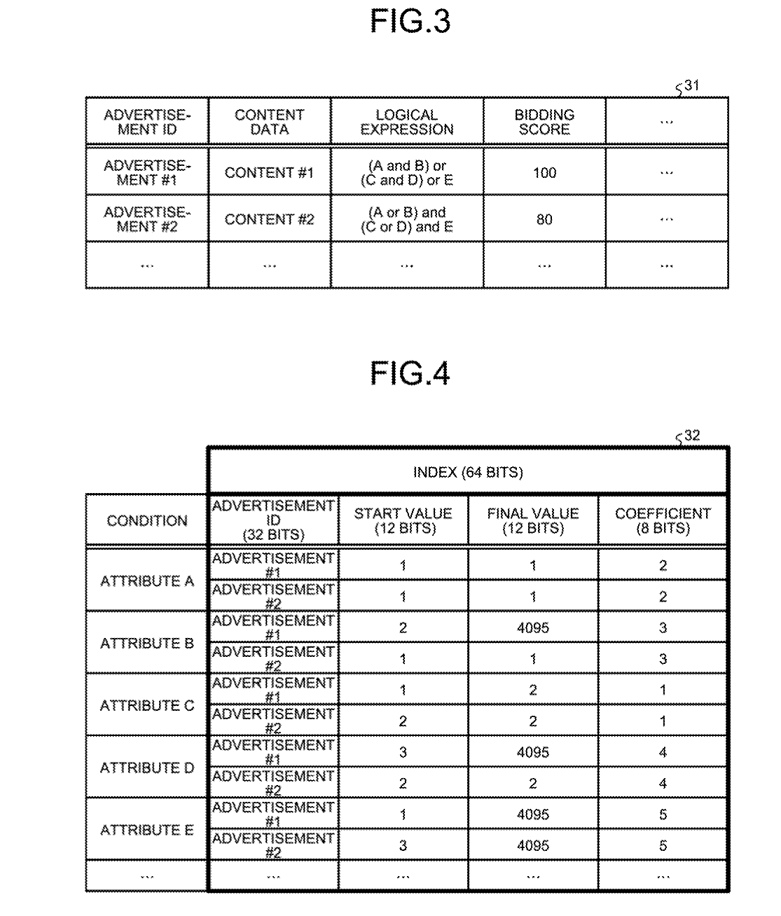

In the advertisement database 31, an advertisement that becomes the distribution target is registered. For example, FIG. 3 is a diagram illustrating an example of information registered in the advertisement database according to the embodiment. In the example illustrated in FIG. 3, in the advertisement database 31, the information, such as “advertisement ID”, “content data”, “logical expression”, and “bidding score”, and the like, is registered. Furthermore, in the advertisement database 31, in addition to the information illustrated in FIG. 3, for example, arbitrary information, such as the click-through rate (CTR), cost per mille (CPM), or the like, related to an advertisement may also be registered.

Here, the “advertisement ID” is an identifier for identifying an advertisement. The “content data” is data on the content, which is displayed as the advertisement, such as an image, a text, or the like, of the advertisement indicated by the associated “advertisement ID”. Furthermore, the “logical expression” is the logical expression indicating the attribute of the user who becomes the target for the distribution destination of the advertisement indicated by the associated “advertisement ID”, i.e., the logical expression indicating the condition of the attribute of the distribution destination. Furthermore, the “bidding score” is a bidding score of an advertisement indicated by the “advertisement ID”.

For example, in the example illustrated in FIG. 3, in the advertisement database 31, the advertisement ID “advertisement #1”, the content data “content #1”, the logical expression “(A and B) or (C and D) or E”, and the bidding score “100” are registered. This information indicates that the data on the content displayed as the advertisement indicated by the advertisement ID “advertisement #1” is the content data “content #1”; indicates that the distribution destination of the attribute indicated by the logical expression “(A and B) or (C and D) or E” is the target; and indicates that the bidding score at the time of hit of the condition is the bidding score of “100”.

Furthermore, in the example illustrated in FIG. 3, conceptual values, such as the “advertisement #1”, the “content #1”, or the like, are represented; however, in practice, in the advertisement database 31, a numerical value or a character string that identifies the advertisement or the data on the characters, images, or the like, constituting the content is registered.

A description will be continued by referring back to FIG. 2. The index of each of the advertisements is registered in the index database 32. For example, FIG. 4 is a diagram illustrating an example of information registered in the index database according to the embodiment. In the example illustrated in FIG. 4, items, such as “condition”, “advertisement ID (32 bits)”, “start value (12 bits)”, “final value (12 bits)”, and “coefficient (8 bits)” are registered in the index database 32. Furthermore, the number of bits described in the parentheses in each of the items is the information indicating the data length of each of the items and the descriptions thereof will be omitted in a description below.

Here, the “condition” is a condition included in the logical expression of each of the items and is the information indicating the attribute of the user who becomes the target for the distribution destination of the advertisement. Furthermore, the “start value” is a start value of the continuous values. Furthermore, the “final value” is a final value of the continuous values. Furthermore, the “coefficient” indicates a coefficient that is set with respect to the “condition” about the advertisement indicated by the associated “advertisement ID”.

For example, in the example illustrated in FIG. 4, the condition “attribute A”, the advertisement ID “advertisement #1”, the start value “1”, the final value “1”, and the coefficient “2” are registered in an associated manner. This information indicates that, regarding the advertisement indicated by the advertisement ID “advertisement #1”, the start value “1” of the continuous values and the final value “1” of the continuous values are set in the condition “attribute A” (i.e., the condition “A”) and the coefficient “2” is set in the condition “attribute A”.

Furthermore, from among the pieces of the information illustrated in FIG. 4, the “condition” is the information that is different from that of the index main body and, in the index, 64-bit information constituted from the “advertisement ID”, the “start value”, the “final value”, and the “coefficient” is included. Namely, the index is information that has the data length that can be read, by a single access, by the core of the arithmetic processing device that performs arithmetic processing in the information distribution device 10.

Furthermore, the data structure of the index database 32 is not limited to the configuration illustrated in FIG. 4. For example, in the index database 32, a different page may also be used for each condition that can be set and an index associated with each page may also be registered. Furthermore, in FIG. 4, an example of the index has been described that contains the advertisement in which the logical expression “(A and B) or (C and D) or E” has been set and the advertisement in which the logical expression “(A or B) and (C or t) and E” has been set.

In this way, regarding each of a plurality of conditions that indicates the attribute of the distribution destination and for which an advertisement becomes the distribution target if the logical conjunction is satisfied, the index database 32 stores therein, in an associated manner, the indexes that include the continuous values constituting the values continued up to a predetermined value at the time of connection and the coefficients. Namely, regarding a certain advertisement, the index database 32 stores therein a plurality of combinations of the plurality of conditions for which an advertisement becomes the distribution target when a logical conjunction is satisfied. Furthermore, if each of the plurality of combinations includes the plurality of conditions and if the logical disjunction of the conditions included in each of the combinations is satisfied, the index database 32 stores therein the indexes, in an associated manner, regarding each of the plurality of the conditions for which an advertisement becomes the distribution target.

A description will be continued by referring back to FIG. 2. The control unit 40 is a controller and is implemented by, for example, a processor, such as a central processing unit (CPU), a micro processing unit (MPU), or the like, executing various kinds of programs, which are stored in a storage device in the information distribution device 10, by using a RAM or the like as a work area. Furthermore, the control unit 40 is a controller and may also be implemented by, for example, an integrated circuit, such as an application specific integrated circuit (ASIC), a field programmable gate array (FPGA), or the like. Furthermore, the control unit 40 corresponds to an arithmetic processing device that reads the index.

As illustrated in FIG. 2, the control unit 40 includes a registration receiving unit 41, an index creating unit 42, a request receiving unit 43, a determination unit 44, a decision unit 45, a calculation unit 46, and a distributing unit 47. The registration receiving unit 41 receives registration of an advertisement. For example, the registration receiving unit 41 receives, from the distribution source server 300, the content data of the advertisement that becomes the distribution target, the logical expression that includes the condition of the distribution destination, a bidding score, and a coefficient for each of the conditions. In such a case, the registration receiving unit 41 creates the advertisement ID and provides the advertisement ID and various kinds of data to the index creating unit 42.

The index creating unit 42 creates an index of an advertisement. For example, the index creating unit 42 allocates the continuous values to each of the conditions by analyzing the received logical expression, by allocating the same range from among the continuous values of 1 to 4095 to a plurality of features constituting the logical disjunction, and by allocating the continuous values of 1 to 4095 to one or a plurality of features constituting the logical conjunction. Furthermore, if the condition expression becomes a plurality of logical disjunctions of logical conjunctions, the index creating unit 42 allocates the continuous values to the condition included in each of the logical conjunctions such that the values of the final value do not overlap. Then, the index creating unit 42 creates, for each condition, the index in which the advertisement ID, the start value of the continuous values, the final value of the continuous values, and the coefficient are associated and then registers the created index in the index database 32. Furthermore, the index creating unit 42 registers the advertisement ID, the content data, the logical expression and the bidding score in the advertisement database 31.

The request receiving unit 43 receives an advertisement request from the user terminal 200. In such a case, the request receiving unit 43 sends the information on the user U01 who uses the user terminal 200 to the log server 100 and acquires the attribute information on the user U01. For example, the request receiving unit 43 sends the terminal identifier that identifies the user terminal 200 as the information that indicates the user U01 and then acquires the attribute information on the user U01. Then, the request receiving unit 43 provides the received attribute information to the determination unit 44 as a query.

If the determination unit 44 receives a plurality of pieces of attribute information indicating the attribute of the distribution destination, the determination unit 44 determines whether each of the pieces of the attribute information matches each of the conditions. For example, the determination unit 44 determines, based on the dynamic programming, whether the attribute information matches the condition that is included in the combination in which the value of the end of the continuous values associated with the condition that is determined to be matched with the attribute information is the smallest from among the combinations of the logical conjunctions.

More specific example will be described. Furthermore, in a description below, it is assumed that the pieces of the information illustrated in FIGS. 3 and 4 are registered in the databases 31 and 32, respectively. For example, the determination unit 44 refers to the final value of the index that includes the advertisement ID “advertisement #1” and selects the condition “A” associated with the index in which the value of the final value is the smallest. Here, if the attribute “A” is included in the query, the determination unit 44 stores “1” in the element, in the determination matrix, that is associated with the start value “1” and the final value “1” of the condition “A”. Then, the determination unit 44 refers to the final value of the index including the advertisement ID “advertisement #1” and selects the condition “C” associated with the index in which the value of the final value is the smallest. Here, if the attribute “C” is included in the query, the determination unit 44 stores “1” in the element, in the determination matrix, that is associated with the start value “1” and the final value “2” of the condition “C”. By recursively performing this process, the determination unit 44 determines whether each of the conditions of the advertisements matches the attribute information of the query.

The decision unit 45 decides whether the advertisement is specified as the distribution target on the basis of whether the continuous values included in the index that is associated with the condition that is determined to be matched with the attribute information continue up to the predetermined value. For example, if the values of the start value and the final value are registered in the determination matrix by the determination unit 44 and “1” is consequently registered in the bottom of the determination matrix, i.e., if the continuous values of 1 to the predetermined value are allocated to the condition matched with the attribute information, the decision unit 45 specifies the advertisement as the distribution target.

Every time it is determined that the attribute information matches the condition, the calculation unit 46 calculates a bidding score at the time of distribution of the advertisement by using the coefficient included in the index associated with the condition that is determined to be matched with the attribute information. More specifically, the calculation unit 46 calculates, for each combination of the logical conjunction, the coefficient product of the coefficients included in the index associated with the conditions determined to be matched with the attribute information and specifies the calculated coefficient product as the bidding score.

For example, if the attribute information matches the condition, the calculation unit 46 calculates the coefficient product of the value of the coefficient associated with the subject condition and the coefficient that is associated with the condition matched with the attribute information from among the conditions included in the combinations of the logical conjunction including the subject condition. Then, if the value of the calculated product is greater than the value of the product of the coefficient associated with the condition that is matched with the attribute information from among the conditions included in the combinations of the other logical conjunctions, the calculation unit 46 holds the value of the calculated logical conjunction in association with the combination of the logical conjunction that includes the condition matched with the attribute information. In contrast, if the value of the calculated product is equal to or less than the value of the coefficient product of the coefficient associated with the condition that is matched with the attribute information from among the conditions included in the combinations of the other logical conjunctions, the calculation unit 46 discards the value of the calculated coefficient product.

For example, the calculation unit 46 prepares an array for each combination of the logical conjunction and specifies, if the condition matches the attribute information, the array associated with the combination of the logical conjunction that includes the subject condition, whereas, if no value is stored in the specified array, the calculation unit 46 stores the coefficient of the condition that is matched with the attribute information. In contrast, the calculation unit 46 specifies the array associated with the combination of the logical conjunction that includes the condition matched with the attribute information and calculates, if a value is stored in the specified array, the coefficient product of the subject value and the coefficient of the condition that is matched with the attribute information. Then, the calculation unit 46 determines whether the value of the calculated coefficient product is greater than the value that is stored in each of the arrays and registers the calculated coefficient product in the specified array only when it is determined that that value is greater.

Furthermore, if the attribute information matches the condition, the calculation unit 46 calculates the product of the value of the coefficient associated with the subject condition and the coefficient associated with the condition matched with the attribute information from among the conditions included in the combinations of the logical disjunction that is other than the combination of the logical disjunction including the subject condition and that constitutes the logical conjunction with the combination of the logical disjunction that includes the subject condition. Then, if the value of the calculated product is greater than the value of the product calculated up to that time, the calculation unit 46 holds the value of the calculated product in association with the combination that includes the condition that is matched with the attribute information, whereas, if the value of the calculated product is equal to or less than the value of the product calculated up to that time, the calculation unit 46 discards the value of the calculated product.

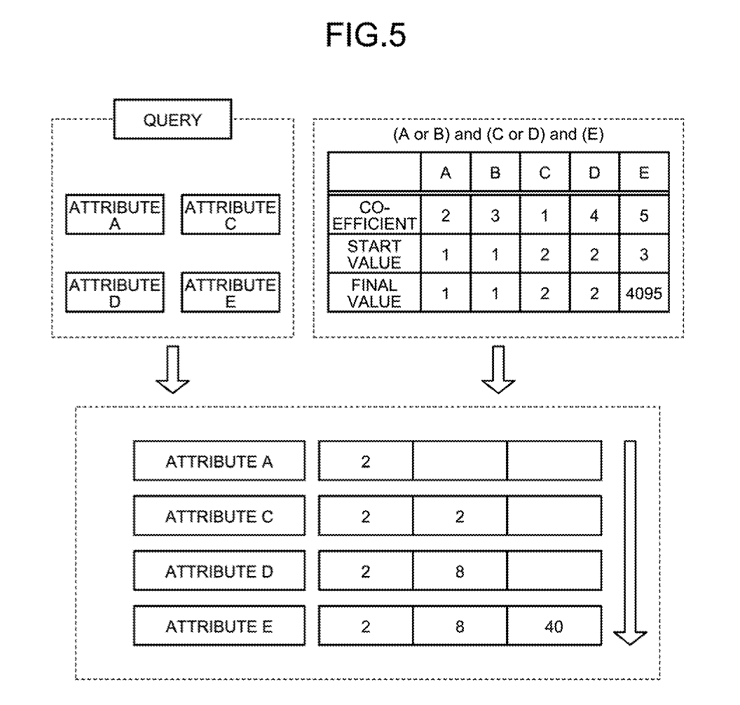

For example, FIG. 5 is a diagram illustrating an example of a process in which the information distribution device according to the embodiment calculates coefficient product. Furthermore, in the example illustrated in FIG. 5, an example has been described in which the attribute information corresponding to the query is the attributes “A”, “C”, “D”, and “E” and the logical expression indicating the distribution destination of the advertisement is “(A or B) and (C or D) and E”. Furthermore, in the example illustrated in FIG. 5, it is assumed that the information distribution device 10 has received the coefficient “2” with respect to the condition “A”, the coefficient “3” with respect to the condition “B”, the coefficient “1” with respect to condition “C”, the coefficient “4” with respect to condition “D”, and the coefficient “5” with respect to condition “E”.

In such a case, for example, the index creating unit 42 allocates the start value “1” and the final value “1” to the condition “A” as the continuous values and allocates the start value “1” and the final value “1” to the condition “B” as the continuous values. Furthermore, the index creating unit 42 allocates the start value “2” and the final value “2” to the condition “C” as the continuous values, allocates the start value “2” and the final value “2” to the condition “D” as the continuous values, and allocates the start value “3” and the final value “4095” to the condition “E” as the continuous values. Consequently, the determination unit 44 determines whether the conditions match the attribute information in the order of the conditions “A”, “B”, “C”, “D”, and “E”.

Here, the condition “A” matches the attribute “A” of the query. Thus, the calculation unit 46 stores the coefficient “2” of the condition “A” in the array associated with the combination of the logical disjunction that includes the condition “A”. Then, because the condition “B” does not match the attribute of the query, the calculation unit 46 waits the process. Subsequently, the condition “C” matches the attribute “C” of the query. Thus, the calculation unit 46 calculates the product of the coefficient “1” of the condition “C” and the coefficient of the condition matched with the attribute information in the combination of the logical disjunction that is other than the combination of the logical disjunction that includes the condition “C”. For example, the calculation unit 46 calculates the product “2” of the coefficient “2” of the condition “A” and the coefficient “1” of the condition “C” that are stored in the array and stores the calculated value of “2” in the array that is associated with the combination of the logical disjunction that includes the condition “C”.

Then, the condition “D” matches the attribute “D” of the query. Thus, the calculation unit 46 calculates the product of the coefficient “4” of the condition “D” and the coefficient of the condition that is matched with the attribute information in the combination of the logical disjunction that is other than the combination of the logical disjunction that includes the condition “D”. For example, the calculation unit 46 calculates the product “8” of the coefficient “2” of the condition “A” and the coefficient “4” of the condition “D” that are stored in the array and determines whether the calculated value “8” is greater than the values that have already been stored in the array associated with the combination of the logical disjunction that included the condition “C”. Then, the calculation unit 46 determines that the product “8” of the coefficient “2” of the condition “A” and the coefficient “4” of the condition “D” and stores the value of the product “8” in the array that is associated with the combination of the logical disjunction associated with the condition “D”.

Then, the condition “E” matches the attribute “E” of the query. Thus, the calculation unit 46 calculates the product of the coefficient “5” of the condition “E” and the coefficient of the condition that is matched with the attribute information in the combination of the logical disjunction that is other than the combination of the logical disjunction that includes the condition “E”. For example, the calculation unit 46 calculates the product “40” of the value “8” that is the greatest value from among the coefficients stored in the array and the coefficient “5” of the condition “E”. Namely, the calculation unit 46 calculates the product of the coefficient of the condition “A”, the coefficient of the condition “D”, and the coefficient of the condition “E”. Then, the calculation unit 46 stores the value of the product “40” in the array that is associated with the combination of the logical disjunction associated with the condition “E”. Consequently, the calculation unit 46 can store, in the array, the maximum value of the value of the coefficient product in a case where the logical expression is satisfied.

Furthermore, the calculation unit 46 calculates a bidding score by using the maximum value of the coefficient product calculated by various kinds of processes described above. For example, the calculation unit 46 calculates the product of the value of the bidding score of the advertisement that has been decided as the distribution target and the maximum value of the coefficient product. Namely, the calculation unit 46 calculates the bidding score in a case where the advertisement that becomes the distribution target is provided to a user who becomes the target for the distribution destination. Furthermore, the calculation unit 46 may also calculate a bidding score in combination with various kinds of known technologies that calculate bidding scores.

Furthermore, if the condition indicating the attribute of the user who does not become the target for the distribution destination of the advertisement matches the attribute information, the calculation unit 46 may also calculate a bidding score by inverting the sign of the value of the coefficient associated with the subject condition. For example, if the query is the attribute “A” in the logical expression “not A” that includes the condition “A”, the calculation unit 46 may also calculate a bidding score by inverting the sign of the coefficient of the condition “A”.

Furthermore, if a plurality of conditions indicating the attribute of the user who does not become the target for the distribution destination of the advertisement matches the attribute information, the calculation unit 46 may also set a flag indicating that the subject advertisement is excluded from the distribution target. For example, if the query is the attributes “A” and “B” in the logical expression “(not A) and (not B)” including the conditions “A” and “B”, the calculation unit 46 may also exclude the subject advertisement from the distribution target by setting the flan indicating that the subject advertisement is excluded from the distribution target.

The distributing unit 47 selects, in accordance with the value of the bidding score, the advertisement that becomes the distribution target from among the advertisements in each of which query corresponding to the attribute information satisfies the logical expression and distributed the selected advertisement. For example, the distributing unit 47 selects a predetermined number of advertisements, from among the advertisements in each of which the attribute information corresponding to the query satisfy the logical expression, in descending order of the value of the bidding scores calculated by the calculation unit 46. Then, the distributing unit 47 distributes the content data of the selected advertisement to the user terminal 200.

4. Example of the Flow of a Process Performed by the Information Distribution Device

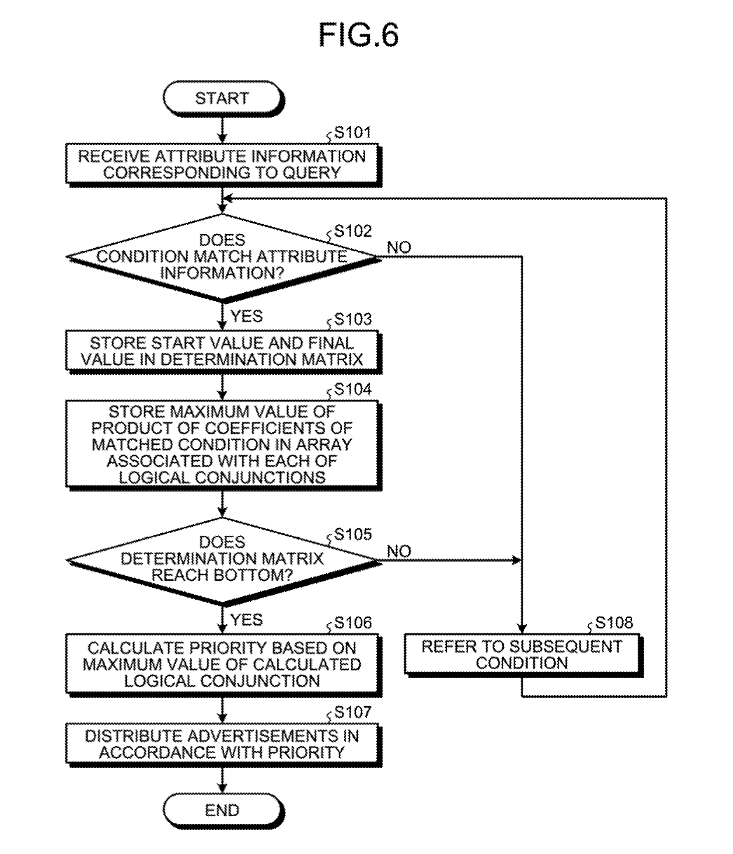

Then, the flow of the calculation process performed by the information distribution device 10 will be described with reference to FIG. 6. FIG. 6 is a flowchart illustrating an example of the flow of a calculation process performed by the information distribution device according to the embodiment. Furthermore, the information distribution device 10 can perform the process in parallel illustrated in FIG. 6 for each advertisement.

For example, the information distribution device 10 receives the attribute information corresponding to the query from the log server 100 (Step S101). In such a case, the information distribution device 10 determines whether the condition matches the attribute information (Step S102) and, if it is determined that both match (Yes at Step S102), the information distribution device 10 stores the start value and the final value of the subject condition in the determination matrix (Step S103). Furthermore, the information distribution device 10 stores the maximum value of the product of the coefficients of the matched condition in the array associated with each of the logical conjunctions (Step S104). Then, the information distribution device 10 determines whether the determination matrix reaches the bottom (Step S105) and, if it reaches (Yes at Step S105), calculates a bidding score indicating the priority based on the maximum value of the calculated logical conjunction (Step S106). Then, the information distribution device 10 distributes the advertisement in accordance with the priority (Step S107) and ends the process.

In contrast, if the determination matrix does not reach the bottom (No at Step S105), the information distribution device 10 refers to the subsequent condition (Step S108) and determines whether the condition matches the attribute information (Step S102). Furthermore, if the condition does not match the attribute information (No at Step S102), the information distribution device 10 also performs the process at Step S107.

5. Modification

In the above description, an example of the calculation process performed by the information distribution device 10 has been described. However, the embodiment is not limited to this. In the following, a variation in the calculation process performed by the information distribution device 10 will be described.

5-1. About Purpose of the Process

In the example described above, the information distribution device 10 distributes an advertisement as the distribution target. However, the embodiment is not limited to this. For example, the information distribution device 10 may also use arbitrary information, such as image content, voice content, moving image content, an electronic book, a news feed, a story of microblog, or the like, as the distribution target as long as the distribution target is changed in accordance with the attribute of the distribution destination. Furthermore, the information distribution device 10 may also distribute not only the content that is in accordance with the attribute of the distribution destination but also the content that matches, for example, the condition desired by the distribution destination.

Furthermore, the information distribution device 10 does not need to distribute the content to the user U01 but may also distribute various kinds of servers, or the like. Namely, the calculation process described above may also calculate a priority that is used at the time of selecting arbitrary content corresponding to the distribution target based on an arbitrary condition with respect to an arbitrary distribution destination as long as the priority used at the time of selecting the content corresponding to the distribution target is calculated based on the condition associated with the distribution destination, such as an attribute, a desire, or the like, of the distribution destination.

5-2. About a Coefficient

In the example described above, the information distribution device 10 receives a coefficient having a value of an integer; however, the embodiment is not limited to this. For example, the information distribution device 10 may also receive, as coefficients, the values of “0.0” to “2.0” in increments of “0.1”. In such a case, if the number of elements included in the logical expression is “n”, the information distribution device 10 receives the values up to the n^{th} power of 2 as the maximum value of the coefficient product.

Here, if the data size of the index is considered, if the maximum value of the coefficient product is a value that does not exceed the maximum value of double precision floating point, the handling of overflow is not needed. Thus, for example, if the maximum value of the element included in the logical expression is “18”, the maximum value of the coefficient is “131072”; therefore, this does not exceeds the maximum value of double precision floating point.

5-3. Device Configuration

The information distribution device 10 may also be connected to an arbitrary number of the user terminals 200 such that they can communicate each other. Furthermore, the information distribution device 10 may also be implemented by a front end server that sends and receives information to and from the user terminal 200 and the distribution source server 300 and a back end server that performs the decision process. In such a case, the registration receiving unit 41 and the distributing unit 47 illustrated in FIG. 2 are disposed in the front end server, whereas the back end server includes the index creating unit 42, the request receiving unit 43, the determination unit 44, the decision unit 45, and the calculation unit 46. Furthermore, each of the databases 31 and 32 registered in the storage unit 30 may also be held by an external storage server.

5-4. Others

Of the processes described in the embodiment, the whole or a part of the processes that are mentioned as being automatically performed can also be manually performed, whereas the whole or a part of the processes that are mentioned as being manually performed can also be automatically performed using known methods. Furthermore, the flow of the processes, the specific names, and the information containing various kinds of data or parameters indicated in the above specification and drawings can be arbitrarily changed unless otherwise stated. For example, the various kinds of information illustrated in each of the drawings are not limited to the information illustrated in the drawings.

The components of each device illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions.

Furthermore, each of the embodiments described above can be appropriately used in combination as long as the processes do not conflict with each other.

5-5. Program

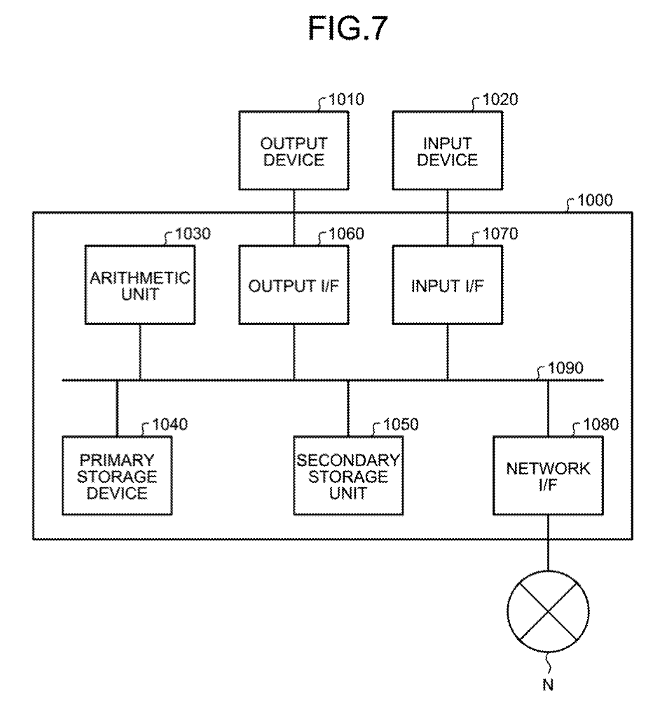

Furthermore, the information distribution device 10 according to the embodiment described above is implemented by a computer 1000 having the configuration illustrated in, for example, FIG. 7. FIG. 7 is a block diagram illustrating an example of hardware configuration. The computer 1000 is connected to an output device 1010 and an input device 1020 and has the configuration in which an arithmetic unit 1030, a primary storage device 1040, a secondary storage unit 1050, an output interface (I/F) 1060, an input I/F 1070, a network I/F 1080 are connected via a bus 1090.

The arithmetic unit 1030 is operated based on the programs stored in the primary storage device 1040 or the secondary storage unit 1050 or based on the programs read from the input device 1020 and performs various kinds of processes. The primary storage device 1040 is a memory device, such as a RAM, or the like, that primarily stores therein data that is used by the arithmetic unit 1030 to perform various kinds of arithmetic operations. Furthermore, the secondary storage unit 1050 is a storage device in which data that is used by the arithmetic unit 1030 to perform various kinds arithmetic operations and various kinds of databases are registered and is implemented by a read only memory (ROM), an HDD, a flash memory, and the like.

The output I/F 1060 is an interface for sending information that is targeted for an output with respect to the output device 1010, such as a monitor, a printer, or the like, that outputs various kinds of information and is implemented by, for example, the standard connector, such as a universal serial bus (USB), a digital visual interface (DVI), a High Definition Multimedia Interface (registered trademark) (HDMI), or the like. Furthermore, the input I/F 1070 is an interface for receiving information from various kinds of the input device 1020, such as a mouse, a keyboard, a scanner, or the like, and is implemented by, for example, an USB, or the like.

Furthermore, the input device 1020 may also be, for example, an optical recording medium, such as a compact disc (CD), a digital versatile disc (DVD), a phase change rewritable disk (PD), or the like; a magneto-optical recording medium, such as a magneto-optical disk (MO), or the like; or a device that reads information from a tape medium, a magnetic recording medium, a semiconductor memory, or the like. Furthermore, the input device 1020 may also be an external storage medium, such as a USB memory, or the like.

The network I/F 1080 receives data from another device via the network N and sends the data to the arithmetic unit 1030. Furthermore, the network I/F 1080 sends the data created by the arithmetic unit 1030 to the other device via the network N.

The arithmetic unit 1030 controls the output device 1010 or the input device 1020 via the output I/F 1060 or the input I/F 1070, respectively. For example, the arithmetic unit 1030 loads the program from the input device 1020 or the secondary storage unit 1050 into the primary storage device 1040 and executes the loaded program.

For example, if the computer 1000 functions as the information distribution device 10, the arithmetic unit 1030 in the computer 1000 implements the function of the control unit 40 by executing the program loaded in the primary storage device 1040.

6. Effects

As described above, if the information distribution device 10 receives a plurality of pieces of attribute information indicating the attribute of the distribution destination, the information distribution device 10 refers to, regarding a plurality of conditions that indicate an attribute and for which predetermined information, such as an advertisement, becomes the distribution target if a logical conjunction is satisfied, the index database 32 that stores therein, in an associated manner, indexes each of which includes continuous values constituting values continued up to a predetermined value at the time of connection and a coefficient. Then, the information distribution device 10 determines whether each of the pieces of the attribute information matches with each of the conditions. Furthermore, the information distribution device 10 decides, on the basis of whether the continuous values included in the index that is associated with the condition determined to be matched with the attribute information continue up to the predetermined value, whether the predetermined information is specified as the distribution target. Then, every time it is determined that attribute information matches with the condition, by using the coefficient that is included in the index and that is associated with the condition that is determined to be matched with the subject attribute information, the information distribution device 10 calculates a priority, such as a bidding score, or the like, at the time of distribution of the predetermined information.

In this way, the information distribution device 10 refers to the index that includes the continuous values in the interval algorithm, that is set for each condition, and that includes a coefficient for each attribute and then calculates a priority by using the coefficient every time the condition matches the attribute information. Consequently, because the information distribution device 10 can perform, in parallel, a process of determining whether the condition matches the attribute information and a process of calculating a coefficient, it is possible to reduce the time taken to extract the information that becomes the distribution target.

Furthermore, the information distribution device 10 calculates, for each of the combinations of logical conjunctions that are combinations of a plurality of conditions for which the predetermined information becomes the distribution target if the logical conjunction is satisfied, by using the coefficient included in the index associated with the condition determined to be matched with the attribute information, a priority at the time of distribution of the predetermined information. For example, the information distribution device 10 calculates, for each combination of the logical conjunction, the product of the coefficients included in the index associated with the conditions determined to be matched with the attribute information as the priority. Consequently, the information distribution device 10 can appropriately calculate the priority in a case where the attribute information satisfies the logical expression.

Furthermore, the information distribution device 10 determines whether the condition that is included in the combination in which the value of the end of the continuous values associated with the condition that is determined to be matched with the attribute information is the smallest from among the combinations of the logical conjunctions matches the attribute information. Namely, the information distribution device 10 determines whether each of the conditions matches the attribute information in the order that is based on the dynamic programming. Consequently, the information distribution device 10 can efficiently determine whether the attribute information matches the condition.

Furthermore, if the attribute information matches the condition, the information distribution device 10 calculates the product of the value of the coefficient associated with the subject condition and the coefficient associated with the condition that is matched with the attribute information from among the conditions included in the combination of the logical conjunction that includes the subject condition. Then, if the value of the calculated product is greater than the value of the product of the coefficient associated with the condition matched with the attribute information from among the conditions included in the combination of the other logical conjunction, the information distribution device 10 holds the value of the calculated product in association with the combination of the logical conjunction that includes the condition matched with the attribute information. In contrast, if the value of the calculated product is equal to or less than the product of the coefficient associated with the condition that is matched with the attribute information from among the conditions included in the combination of the other logical conjunction, the information distribution device 10 discards the value of the calculated product. Then, for example, if the attribute information matches the condition, the information distribution device 10 calculates the product of the value of the coefficient associated with the subject condition and the value of the product associated with the combination of the logical conjunction that includes the subject condition. Consequently, because the information distribution device 10 can reduce, for example, the number of initializations of an array to one time, the information distribution device 10 can efficiently calculate the value of the priority if combinations of a plurality of logical conjunctions constituting logical disjunctions are present.

Furthermore, if each of the plurality of combinations of a plurality of logical disjunctions each include a plurality of conditions and if each of the logical disjunctions of the conditions included in combinations of each of the logical disjunctions is satisfied, the information distribution device 10 stores the index in association with each of the plurality of conditions for which the predetermined information becomes the distribution target. Then, if the attribute information matches the condition, the information distribution device 10 calculates the product of the value of the coefficient associated with the subject condition and the coefficient associated with the condition matched with the attribute information from among the conditions included in the combinations of the logical disjunctions other than the combination of the logical disjunction that includes the subject condition and holds, if the value of the calculated product is greater than the value of the product calculated up to that time, the information distribution device 10 holds the value of the calculated product in association with the combination of the logical disjunction that includes the condition matched with the attribute information. In contrast, if the value of the calculated product is equal to or less than the value of the product calculated up to that time, the information distribution device 10 discards the value of the calculated product. Consequently, the information distribution device 10 can also efficiently calculate the value of the priority, even if combinations of a plurality of logical disjunctions constituting the logical conjunction are present.

Furthermore, if the condition indicating the attribute of the distribution destination that does not become the distribution destination of the predetermined information matches the attribute information, the information distribution device 10 inverts the sign of the value of the coefficient associated with the subject condition and calculates a priority. Furthermore, if all of the conditions included in the combinations of the conditions constituting the logical conjunction are the conditions that indicate the attribute of the distribution destination that does not become the distribution destination of the predetermined information and if all of the conditions match the attribute information, the information distribution device 10 sets a flag indicating that the predetermined information is excluded from the distribution target. Consequently, the information distribution device 10 can also appropriately calculate a value of a priority even if the logical expression including non-conjunction or non-disjunction is set.

Furthermore, the information distribution device 10 refers to, as the index, the index database 32 that stores therein information that includes the identifiers for identifying the predetermined information, the continuous values, and the coefficients and that has the data length equal to or less than the number of bits that can be read by the arithmetic processing device by a single access. Consequently, because the information distribution device 10 can include the latency caused by a coefficient to be read in the latency at the time of reading of the index, it is possible to reduce the time taken to extract the information that becomes the distribution target.

Furthermore, the index used by the information distribution device 10 described above includes, regarding each of a plurality of conditions that indicates the attribute of the distribution destination and for which the predetermined information becomes the distribution target if a logical conjunction is satisfied, the continuous values constituting values continued up to the predetermined value at the time of connection, the coefficients, and the identifiers that indicate the predetermined information. Consequently, the index can reduce the time needed when the information distribution device 10 extracts the information that becomes the distribution target.

Furthermore, the “components (sections, modules, units)” described above can be read as “means”, “circuits”, or the like. For example, the distributing unit can be read as a distribution means or a distribution circuit.

According to an aspect of an embodiment, it is possible to reduce the time taken to extract information that becomes a distribution target.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A calculation device comprising:
a determination unit that
(i) refers to, when a plurality of pieces of attribute information indicating an attribute of a distribution destination is received, regarding each of a plurality of conditions that indicates an attribute and for which predetermined information becomes the distribution target when a logical conjunction is satisfied, a storage device that stores therein, in an associated manner, index information including continuous values constituting values continued up to a predetermined value at the time of connection and coefficients, and
(ii) that determines whether each of the pieces of the attribute information matches each of the conditions;
a decision unit that decides, on the basis of whether the continuous values included in the index information that is associated with the condition determined to be matched with the attribute information continue up to the predetermined value, whether the predetermined information is specified as the distribution target; and
a calculation unit that calculates, every time it is determined that the attribute information matches the condition, by using the coefficient that is included in the index information and that is associated with the condition that is determined to be matched with the attribute information, a priority at the time of distribution of the predetermined information.

2. The calculation device according to claim 1, wherein
the determination unit refers to a storage device that stores therein a plurality of combinations of the plurality of conditions for which the predetermined information becomes the distribution target when the logical conjunction is satisfied, and
the calculation unit calculates, for each combination, by using the coefficient included in the index information associated with the condition that is determined to be matched with the attribute information, the priority at the time of distribution of the predetermined information.

3. The calculation device according to claim 2, wherein the determination unit determines whether the condition included in the combination, from among the combinations, in which the value of the end of the continuous values associated with the condition that is determined to be matched with the attribute information is the smallest matches the attribute information.

4. The calculation device according to claim 2, wherein the calculation unit calculates, for each combination, the product of the coefficients included in the index information associated with the condition determined to be matched with the attribute information as the priority.

5. The calculation device according to claim 2, wherein,
when the attribute information matches the condition, the calculation unit calculates a product of the value of the coefficient associated with the subject condition and the coefficient associated with the condition matched with the attribute information from among the conditions included in the combination that includes the subject condition,
when the value of the calculated product is greater than the value of the product of the coefficient associated with the condition that is matched with the attribute information from among the conditions included in another combination, the calculation unit holds the value of the calculated product in association with the combination that includes the condition matched with the attribute information, and
when the value of the calculated product is equal to or less than the value of product of the coefficient associated with the condition that is matched with the attribute information from among the conditions included in another combination, the calculation unit discards the value of the calculated product.

6. The calculation device according to claim 5, wherein, when the attribute information matches the condition, the calculation unit calculates the product of the value of the coefficient associated with the subject condition and the value of the product associated with the combination that includes the subject condition.

7. The calculation device according to claim 1, wherein
when each of the plurality of combinations includes the plurality of conditions and when the logical disjunction of the conditions included in each of the combinations is satisfied, the determination unit refers to the storage device that stores therein the index information in an associated manner regarding each of the plurality of the conditions for which the predetermined information becomes the distribution target,
when the attribute information matches the condition, the calculation unit calculates the product of the value of the coefficient associated with the subject condition and the coefficient associated with the condition that is matched with the attribute information from among the conditions that are included in the combination other than the combination that includes the subject condition,
when the value of the calculated product is greater than the value of the product calculated up to that time, the calculation unit holds the value of the calculated product in association with the combination that includes the condition matched with the attribute information, and
when the value of the calculated product is equal to or less than the value of the product up to that time, the calculation unit discards the value of the calculated product.

8. The calculation device according to claim 1, wherein, when the condition indicating an attribute of the distribution destination that does not become the distribution destination of the predetermined information matches the attribute information, the calculation unit calculates the priority by inverting the sign of the value of the coefficient associated with the subject condition.

9. The calculation device according to claim 8, wherein, when all of the conditions included in the combinations of the conditions constituting the logical conjunction are conditions indicating the attribute of the distribution destination that does not become the distribution destination of the predetermined information and when all of the conditions match the attribute information, the calculation unit sets a flag indicating that the predetermined information is excluded from the distribution target.

10. The calculation device according to claim 1, wherein the determination unit refers to a storage device that stores therein information, as the index information, that includes identifiers for identifying the predetermined information, the continuous values, and the coefficients and that has a data length equal to or less than the number of bits that can be read by the arithmetic processing device by a single access.

11. Index information used by the calculation device according to claim 1, the index information including, regarding each of a plurality of conditions that indicates an attribute of a distribution destination and for which predetermined information becomes the distribution target when a logical conjunction is satisfied, the continuous values constituting values continued up to a predetermined value at the time of connection, coefficients, and identifiers that indicate the predetermined information.

12. A calculation method performed by a calculation device, the calculation method comprising:
referring to, when a plurality of pieces of attribute information indicating an attribute of a distribution destination is received, regarding each of a plurality of conditions that indicates an attribute of a distribution destination and for which predetermined information becomes the distribution target when a logical conjunction is satisfied, a storage device that stores therein, in an associated manner, index information including continuous values constituting values continued up to a predetermined value at the time of connection and coefficients;
determining whether each of the pieces of the attribute information matches each of the conditions;
deciding, on the basis of whether the continuous values included in the index information that is associated with the condition determined to be matched with the attribute information continue up to the predetermined value, whether the predetermined information is specified as the distribution target; and
calculating, every time it is determined that the attribute information matches the condition, by using the coefficient that is included in the index information and that is associated with the condition that is determined to be matched with the attribute information, a priority at the time of distribution of the predetermined information.

13. A non-transitory computer-readable recording medium having stored a calculation program that causes a computer to execute a process comprising:
referring to, when a plurality of pieces of attribute information indicating an attribute of a distribution destination is received, regarding each of a plurality of conditions that indicates an attribute of a distribution destination and for which predetermined information becomes the distribution target when a logical conjunction is satisfied, a storage device that stores therein, in an associated manner, index information including continuous values constituting values continued up to a predetermined value at the time of connection and coefficients;
determining whether each of the pieces of the attribute information matches each of the conditions;
deciding, on the basis of whether the continuous values included in the index information that is associated with the condition determined to be matched with the attribute information continue up to the predetermined value, whether the predetermined information is specified as the distribution target; and
calculating, every time it is determined that the attribute information matches the condition, by using the coefficient that is included in the index information and that is associated with the condition that is determined to be matched with the attribute information, a priority at the time of distribution of the predetermined information.
